(19) United States
(12) Patent Application Publication
(10) Pub. No.: US 2014/0229148 A1
(43) Pub. Date: Aug. 14, 2014

(54) APPARATUS, METHOD, PROGRAM, AND STORAGE MEDIUM FOR PREDICTING ACID DISSOCIATION CONSTANT

(71) Applicant: Fujitsu Limited, Kawasaki-shi (JP)

(72) Inventors: Hiroyuki SATO, Yokohama (JP); Azuma MATSUURA, Sagamihara (JP)

(73) Assignee: Fujitsu Limited, Kawasaki-shi (JP)

(21) Appl. No.: 14/068,380

(22) Filed: Oct. 31, 2013

(30) Foreign Application Priority Data
Feb. 14, 2013 (JP) 2013-026464

(51) Int. Cl. G06F 19/00

(52) U.S. Cl. CPC G06F 19/701
USPC 703/2

(57) ABSTRACT

An apparatus for predicting an acid dissociation constant, includes: a memory configured to store index value-containing data, element pair-containing data, and index value group-containing data, the index value-containing data containing an index value of an interatomic bond of a target molecule determined on the basis of the value of the electron density of the interatomic bond, the element pair-containing data containing a coefficient value specific to two elements that serves for the interatomic bond, the index value group-containing data entirely covering the target molecule and being based on the index value-containing data and the element pair-containing data; and an acid dissociation constant prediction unit that predicts an acid dissociation constant from the index value group-containing data and the element pair-containing data.

### CROSS-REFERENCE TO RELATED APPLICATION

This application is based upon and claims the benefit of priority of the prior Japanese Patent Application No. 2013-026464, filed on Feb. 14, 2013, the entire contents of which are incorporated herein by reference.

### FIELD

The embodiment discussed herein is related to prediction of an acid dissociation constant.

### BACKGROUND

pKₐ is a constant that represents acid dissociation equilibrium (acidity) and used as, for example, an index for determining the presence of a proton (H⁺) that is important in a chemical reaction in biomolecules. A variety of techniques for predicting pKₐ have been therefore studied.

Such techniques are broadly classified into two types: a technique based on the thermodynamic theory and a technique involving approximation by a function of a physical property that is a variable.

The former technique enables theoretical calculation, and the latter technique enables generally fast prediction.

In the technique based on the thermodynamic theory, however, not only the prediction is greatly affected by the number and position of water molecules located near a target molecule, but also highly accurate calculation is demanded to obtain good result (see Junming Ho, Michelle L. Coote, “A universal approach for continuum solvent pKₐ calculations: are we there yet?”, Theor Chem Acc, pp. 3-21, 2010). Fast prediction has been therefore still under development. Thus, such a technique is impractical for analysis of macromolecules and screening of mass data.

In the technique involving approximation by a function of a physical property that is a variable, an approach of using a variety of physical properties has been made to enable highly accurate prediction.

In an example of such an approach, the electrical charges of a hydrogen atom (H) dissociated into a proton and oxygen atom (O) directly bonded to H and the distance therebetween are used as variables (see Jahanbakhsh Ghasemi, Saadi Saaidpour, Steven D. Brown, “QSPRstudy for estimation of acidity constants of some aromatic acids derivatives using multiple linear regression (MLR) analysis”, Journal of Molecular Structure, THEOCHEM, pp. 27-32, 2007). In the case of using such variables, however, another function expression is entailed on the basis of, for instance, the type of the acid of a target molecule; in addition, all function expressions have not given highly accurate results (see Mario J. Citra, “ESTIMATING THE pKₐ OF PHENOLS, CARBOXYLIC ACIDS AND ALCOHOLS FROM SEMI-EMPIRICAL QUANTUM CHEMICAL METHODS”, Chemosphere, Vol. 38, No. 1, pp. 191-206, 1999). Hence, such a technique is unsuitable for analysis of novel molecules.

### SUMMARY

According to an aspect of the invention, An apparatus for predicting an acid dissociation constant, includes: a memory configured to store index value-containing data, element pair-containing data, and index value group-containing data, the index value-containing data containing an index value of an interatomic bond of a target molecule determined on the basis of the value of the electron density of the interatomic bond, the element pair-containing data containing a coefficient value specific to two elements that serves for the interatomic bond, the index value group-containing data entirely covering the target molecule and being based on the index value-containing data and the element pair-containing data; and an acid dissociation constant prediction unit that predicts an acid dissociation constant from the index value group-containing data and the element pair-containing data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an acid dissociation constant pKₐ;

FIG. 2 illustrates an example of a method for predicting pKₐ;

FIG. 3 illustrates another example of a method for predicting pKₐ;

FIG. 4 illustrates a configuration example of a molecular design support system according to an embodiment;

FIG. 5 illustrates the hardware configuration of a computer apparatus;

FIG. 6 illustrates an example of the functional configuration of the molecular design support system;

FIG. 7 illustrates a pair type;

FIG. 8 illustrates an example of a process for predicting an acid dissociation constant;

FIG. 9 illustrates the molecular structure of formic acid;

FIG. 10A illustrates results of analysis by related art; and

FIG. 10B illustrates results of analysis by the embodiment.

### DESCRIPTION OF EMBODIMENT

An embodiment will hereinafter be described with reference to the drawings. First of all, a typical method for predicting an acid dissociation constant pKₐ will now be described.

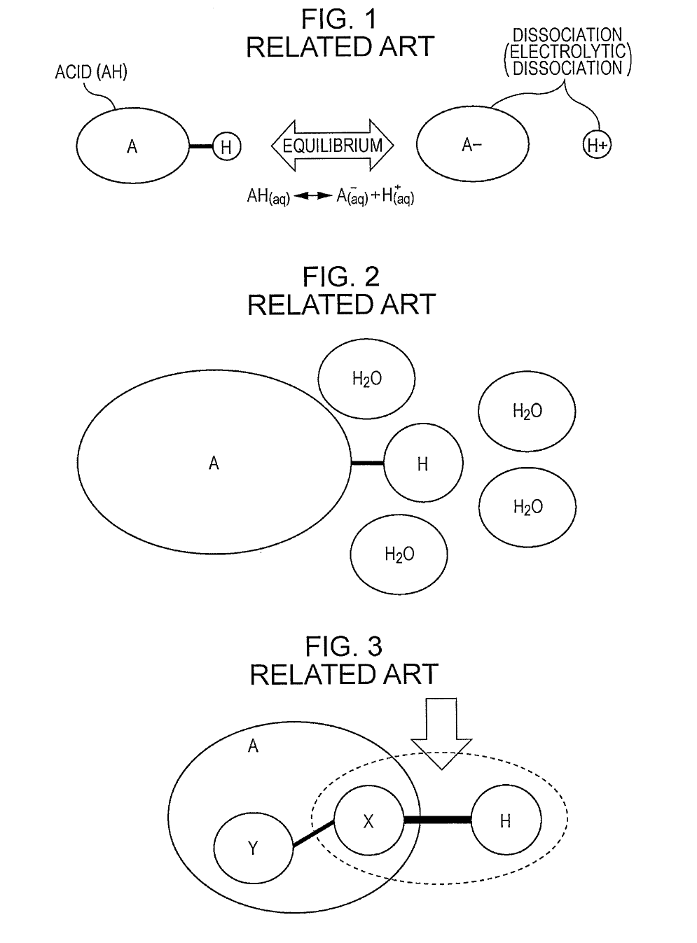

FIG. 1 illustrates an acid dissociation constant pKₐ. pKₐ is a constant that represents acid dissociation equilibrium as illustrated in FIG. 1 and represented by Formula 1.

$$p {K}_{a} = - log {K}_{a} where {K}_{a} = \frac{[ {A}^{-} ] [ {H}^{+} ]}{[ AH ]} \qquad ( 1 )$$

pKₐ serves as an index for determining the presence of a proton (H⁺) that is important in a chemical reaction in biomolecules.

In a known prediction technique, pKₐ is obtained from a definition equation. FIG. 2 illustrates an example of a method for predicting pKₐ. In the prediction technique by a definition equation, pKₐ is defined as a value that is in proportion to a change ΔG in free energy as represented by Formula 2.

$${AH}_{( aq )} {↔}^{AG} {A}_{( aq )}^{-} + {H}_{( aq )}^{+} ⇒ p {K}_{a} ∝ Δ G \qquad ( 2 )$$

In such a prediction technique, a prediction result depends on the number and position of water molecules located near an acid AH illustrated in FIG. 2, and highly accurate calculation is therefore demanded. Hence, such a technique is unsuitable for analysis of macromolecules and screening of mass data.

FIG. 3 illustrates another example of a method for predicting pKₐ. In a prediction technique illustrated in FIG. 3, only the physical properties related to a hydrogen H and an atom X of a molecule A (hereinafter referred to as atom H—X) are utilized. In particular, pKₐ is predicted on the basis of an estimated formula (Formula 3) in which the physical properties related to the atom H—X (d₁, d₂, . . . , d_{N}) are used as variables.

pKₐ≅f(d₁,d₂, . . . , d_{N}) (3)

In this prediction method, however, an estimated formula greatly varies depending on the types of molecules; hence, such a prediction technique is impractical for analysis of novel molecules and prediction of pKₐ in a multistep oxidation reaction.

This embodiment provides a prediction apparatus and prediction method in which an index based on the electron density of an interatomic bond is used to enable fast and highly accurate prediction of the acid dissociation constant pKₐ of a molecule regardless of the types of molecules.

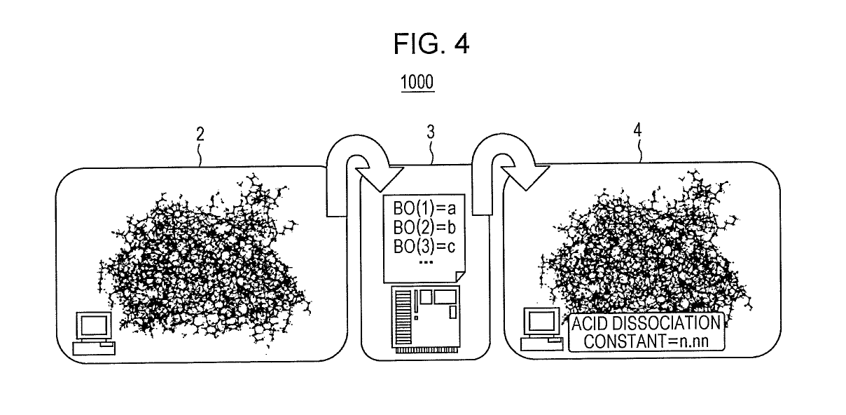

FIG. 4 illustrates a configuration example of a molecular design support system according to the embodiment. With reference to FIG. 4, a molecular design support system 1000 includes a molecular structure design unit 2, an acid dissociation constant prediction unit 3, and a prediction result display unit 4.

The combination of the molecular structure design unit 2, acid dissociation constant prediction unit 3, and prediction result display unit 4, namely, the molecular design support system 1000 may be in the form of one computer apparatus. Alternatively, the molecular structure design unit 2, the acid dissociation constant prediction unit 3, and the prediction result display unit 4 may be in the form of independent computer apparatuses. Furthermore, the combination of the acid dissociation constant prediction unit 3 and the prediction result display unit 4 may be in the form of one computer apparatus; such a computer apparatus corresponds to an acid dissociation constant prediction apparatus.

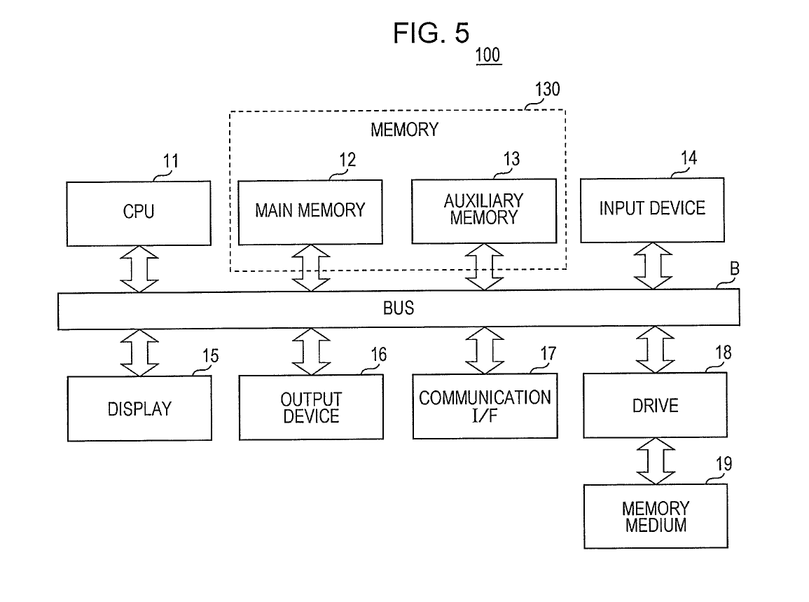

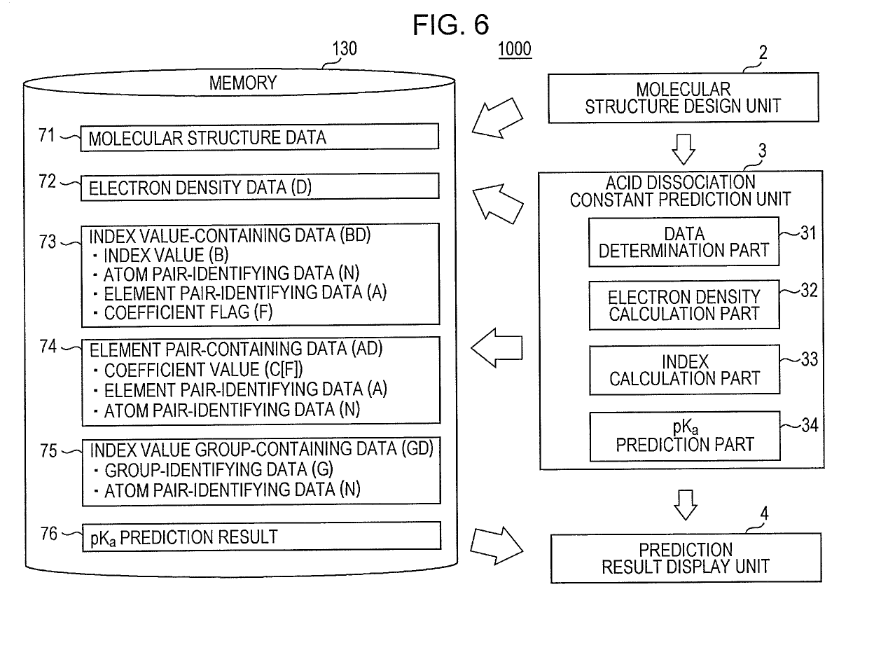

A computer apparatus that serves as the molecular design support system 1000 has, for example, a hardware configuration illustrated in FIG. 5. FIG. 5 illustrates the hardware configuration of a computer apparatus. With reference to FIG. 5, a computer apparatus 100 includes a central processing unit (CPU) 11, a main memory 12, an auxiliary memory 13, an input device 14, a display 15, an output device 16, a communication interface I/F 17, and a drive 18 and is connected to a bus B.

The CPU 11 controls the computer apparatus 100 on the basis of a program stored in the main memory 12. An example of the main memory 12 is a random access memory (RAM), and the main memory 12 stores, for instance, a program that is to be executed by the CPU 11, data used for processing by the CPU 11, and data obtained through processing by the CPU 11. Part of the storage area of the main memory 12 is allocated to a working area used for processing by the CPU 11.

A hard disk drive is used as the auxiliary memory 13 and stores data such as programs used for carrying out various processing. Some of the programs stored in the auxiliary memory 13 are loaded by the main memory 12 and executed by the CPU 11, thereby carrying out various processing. A memory 130 includes the main memory 12 and/or the auxiliary memory 13.

The input device 14 includes, for example, a mouse and a keyboard and is handled by users for inputting a variety of information used for processing by the computer apparatus 100. On the display 15, a variety of useful information is displayed under control of the CPU 11. The output device 16 includes, for instance, a printer and serves to output a variety of information in response to instructions from users. The communication I/F 17 is connected to, for example, internet or local area network (LAN) and serves to control communication with an external apparatus. The communication by the communication I/F 17 is not limited to wireless communication or wire communication.

A program used for processing by the computer apparatus 100 is provided for the computer apparatus 100 from a memory medium 19 such as a compact disc read-only memory (CD-ROM). In particular, once the memory medium 19 storing a program is placed on the drive 18, the drive 18 reads the program from the memory medium 19, and the read program is installed in the auxiliary memory 13 through the bus B. When the program installed in the auxiliary memory 13 is started, the CPU 11 starts processing on the basis of the program. The medium storing a program is not limited to CD-ROMs, and any computer-readable medium may be used. Examples of a computer-readable memory medium other than CD-ROMs include digital versatile discs (DVDs), portable memory media such as a USB memory, and semiconductor memories such as a flash memory.

FIG. 6 illustrates an example of the functional configuration of a molecular design support system. The molecular design support system 1000 includes the molecular structure design unit 2, the acid dissociation constant prediction unit 3, and the prediction result display unit 4 as illustrated in FIG. 6. The memory 130 stores molecular structure data 71, electron density data (D) 72, index value-containing data (BD) 73, element pair-containing data (AD) 74, index value group-containing data (GD) 75, and a pKₐ prediction result 76.

The molecular structure design unit 2 helps users to design a molecular structure. The datum of the molecular structure designed by users (hereinafter referred to as molecular structure data 71) is stored in the memory 130. The molecular structure data 71 include the coordinates of atoms constituting a molecule and information of a dissociated proton.

The acid dissociation constant prediction unit 3 highly accurately predicts an acid dissociation constant pKₐ and includes a data determination part 31, an electron density calculation part 32, an index calculation part 33, and a pKₐ prediction part 34.

In the data determination part 31, atom pairs of the molecular structure designed by users are formed with reference to the molecular structure data 71 and stored in the element pair-containing data (AD) 74 of the memory 130.

The electron density calculation part 32 calculates the molecular orbital and calculates the electron density of the entire molecule. Electron density data (D) that represents the calculated electron density is stored in the memory 130.

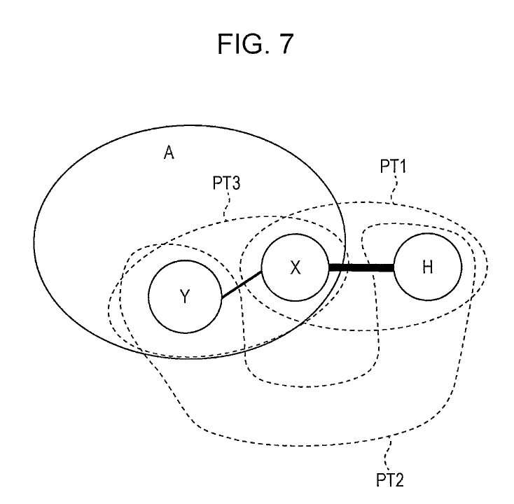

In an example of a simple molecular structure in FIG. 7, a target proton H and a molecule A are illustrated; in the molecule A, X is an atom directly bonded to the target proton H, and Y is an atom which is not bonded to the target proton H. The atom Y may be multiple. Atom pairs formed in the calculation of electron density are classified into the following pair types: a pair type PT1 “H—X”, namely, an atom pair consisting of the target proton H and the atom X directly bonded to the target proton H; a pair type PT2 “H—Y” (all atoms other than the atom X contained in the molecule A), namely, an atom pair consisting of the target proton H and the atom Y other than the atom X directly bonded to the target proton H; a pair type PT 3 “X—Y”, namely, an atom pair including the atom X directly bonded to the target proton H, not including the target proton H; and a pair type PT 4 that is an atom pair other than the pair types PT1 to PT 3.

On the basis of the electron density obtained by the electron density calculation part 32, the index calculation part 33 calculates an index value that represents bond strength.

Through the processing by the electron density calculation part 32 and the index calculation part 33, an index value (Formula 4) is determined from the electron density (D_{ab}) (Formula 5) between atoms a and b with reference to I. Mayer, “Bond Order and Valence Indices: A Personal Account”, Journal of Computational Chemistry Special Issue, Vol. 28, No. 1, Wiley InterScience, Wiley Periodicals, Inc., pp. 204-221, 2007.

$$\begin{matrix}{B}_{ab} = {W}_{ab} = {\sum }_{μ ∈ a} {\sum }_{v ∈ b} {\vert {D}_{μ v} \vert}^{2} \\ where & ( 4 ) \\ {D}_{μ v} = 2 {\sum }_{i}^{occ .} {C}_{μ i} {C}_{vi}^{*} & ( 5 )\end{matrix}$$

In Formula 4, an atom pair is represented by atoms a and b.

The pKₐ prediction part 34 weights the index values of atom pairs related to the target proton H and atom X directly bonded to the target proton H in terms of the types of the element pairs. The pKₐ prediction part 34 determines a pKₐ estimated formula (Formula 6) on the basis of the index value group-containing data (GD) 75.

pKₐ≅f(C_{XY}B_{XY},C_{YH}B_{YH}, . . . , C_{XH}B_{XH}) (6)

Weighed index values (B) are derived from a data set including the element pair-identifying data (A) and atom pair-identifying data (N) of atom pairs included in groups based on the index value group-containing data (GD) 75, thereby determining the pKₐ estimated formula (Formula 6).

The prediction result display unit 4 serves to display result of the prediction of pKₐ by the pKₐ prediction part 34 on the display 15.

The index value-containing data (BD) 73 has a data structure storing the index values of interatomic bonds, which have been determined on the basis of electron density, and includes an index value (B), atom pair-identifying data (N), element pair-identifying data (A), and a coefficient flag (F).

The element pair-containing data (AD) 74 has a data structure storing a coefficient value specific to two elements concerning bonding in intermolecular bonds and includes a coefficient value (C[F]), element pair-identifying data (A), and atom pair-identifying data (N). The coefficient value (C[F]) is determined for each element pair in advance.

The index value group-containing data (GD) 75 has a data structure storing the groups of atom pairs related to the target proton H and the atom X directly bonded to the target proton H and includes group-identifying data (G) and atom pair-identifying data (N).

The items related to weighting of index values based on such data structures are herein specified as follows:
Index value group-containing data GD of group number G: GD[G]
Atom pair-identifying data N of GD[G]: GD[G]→N
Index value-containing data BD to which the group number GD[G]->N belongs: BD[GD[G]→N]
Index value data B of BD[GD[G]→N]: BD[GD[G]→N]→B
Coefficient flag F of BD[GD[G]→N]: BD[GD[G]→N]→F
Element pair-identifying data belonging to BD[GD[G]→N]: BD[GD[G]→N]→A
Element pair-containing data AD to which BD[GD[G]→N]→A belongs: AD[BD[GD[G]→N]→A]
Coefficient value data C of AD[BD[GD[G]→N]→A]: AD[BD[GD[G]→N]→A]→C[BD[GD[G]→N]→F]
Index value data B of BD[GD[G]→N]: BD[GD[G]→N]→B
Hence, the weighting of an index value based on a coefficient value is obtained by the following formula: AD[BD[GD[G]→N]→A]→C[BD[GD[G]→N]→F]×BD[GD[G]→N]→B.

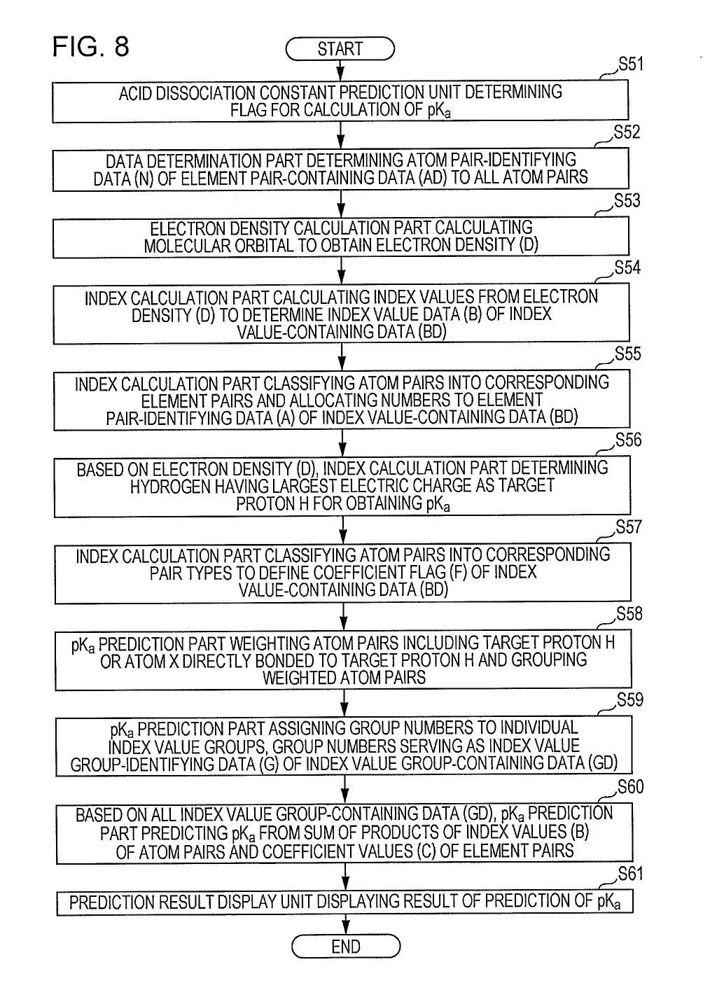

An example of a process for predicting an acid dissociation constant according to the embodiment will now be described with reference to FIG. 8. FIG. 8 illustrates an example of a process for predicting an acid dissociation constant. With reference to FIG. 8, in the acid dissociation constant prediction unit 3, a flag is determined for calculation of pKₐ and starts the process for predicting an acid dissociation constant (step S51). In the acid dissociation constant prediction unit 3, the data determination part 31 determines the atom pair-identifying data (N) of the element pair-containing data (AD) to all atom pairs (step S52). The electron density calculation part 32 calculates a molecular orbital to obtain electron density (D) (step S53).

Then, the index calculation part 33 calculates index values from the electron density (D) to determine the index value data (B) of the index value-containing data (BD) (step S54). The index calculation part 33 classifies the atom pairs into corresponding element pairs and allocates numbers to the element pair-identifying data (A) of the index value-containing data (BD) (step S55).

On the basis of the electron density (D), the index calculation part 33 determines the hydrogen having the largest electric charge as the target proton H for obtaining pKₐ (step S56). The index calculation part 33 classifies the atom pairs into corresponding pair types to define the coefficient flag (F) of the index value-containing data (BD) (step S57).

The pKₐ prediction part 34 weights atom pairs including the target proton H or the atom X directly bonded to the target proton H and then groups the weighted atom pairs (step S58). Atom pairs weighted into the same category are classified into the same group.

The pKₐ prediction part 34 assigns group numbers to the individual index value groups (step S59). The group numbers are determined as the index value group-identifying data (G) of the index value group-containing data (GD).

On the basis of all index value group-containing data (GD), the pKₐ prediction part 34 predicts pKₐ from the sum of products (Formula 6) of the index values (B) of the atom pairs and the coefficient values (C) of the element pairs (step S60).

Result of the prediction of pKₐ is displayed on the display 15 by the prediction result display unit 4 (step S61). In the displaying of the result of the prediction of pKₐ on the display 15, the image of the molecular structure including the target proton H may be displayed on the display 15.

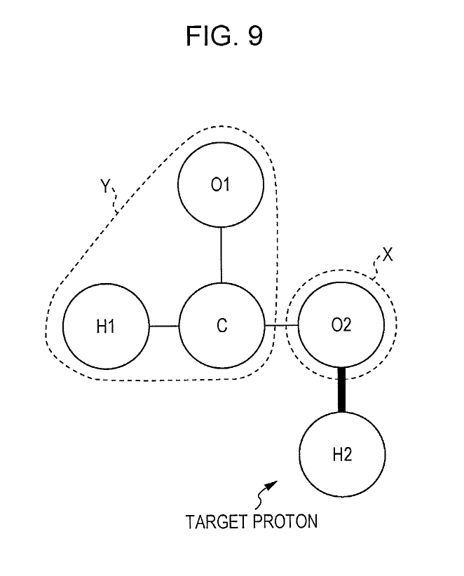

Specific examples of the above-mentioned process for predicting an acid dissociation constant will now be described, in which formic acid is employed as an example. FIG. 9 illustrates the molecular structure of formic acid. Circles represent atomic particles, and the identification names of atoms C, O1, O2, H1, and H2 are given inside the circles to uniquely identify the atoms in the molecular structure.

The atom “H2” is the target proton, the atom “O2” directly bonded to the target proton is an atom X, and the atoms “C”, “O1”, and “H1” not bonded to the target proton H are atoms Y.

The molecular structure data 71 that represents the molecular structure of formic acid is stored in the memory 130.

The data decision part 31 creates atom pairs from the molecular structure of formic acid on the basis of the molecular structure data 71. To each atom pair found in the molecular structure of formic acid, atom pair-identifying data N (N is an integer) is allocated. The atom pairs are identifiable in the index value-containing data BD[N]. Examples of the atom pairs found in the molecular structure of formic acid in FIG. 9 and allocation of the atom pair-identifying data N are as follows:

C—O1: 1

C—O2: 2

C—H1: 3

C—H2: 4

O1-O2: 5

O1-H1: 6

O1-H2: 7

O2-H1: 8

O2-H2: 9

H1-H2: 10

From the identified atom pairs, the data decision part 31 extracts element pairs; in this case, different atom pairs which consist of the same elements are regarded as the same element pair. To each element pair identified through the extraction, the element pair-identifying data A (A is an integer) is allocated. The element pairs are identifiable in the element pair-containing data AD [A]. Examples of the element pairs identified in the atom pairs in the molecular structure of formic acid in FIG. 9 and allocation of the element pair-identifying data A are as follows:

C—O: 1

C—H: 2

O—O: 3

O—H: 4

H—H: 5

In the element pairs and atom pairs which have been identified as described above, the element pairs and the atom pairs corresponding thereto are registered in the form of AD[A]→N; an example thereof in the molecular structure of formic acid in FIG. 9 is as follows:

AD[1]→N[1]=1, AD[1]→N[2]=2

AD[2]→N[1]=3, AD[2]→N[2]=4

AD[3]→N[1]=5

AD[4]→N[1]=6, AD[4]→N[2]=7, AD[4]→N[3]=8, AD[4]→N[4]=9

AD[5]→N[1]=10

Then, the electron density calculation part 32 calculates a molecular orbital and calculates the electron density of each atom pair by Formula 5. The index calculation part 33 obtains the index value B of each atom pair from the obtained electron density by Formula 4.

The index values B of the atom pairs are determined in the index value-containing data (BD) 73 as follows:

BD[1]→B=B_{C-O1}

BD[2]→B=B_{C-O2}

BD[3]→B=B_{C-H1}

BD[4]→B=B_{C-H2}

BD[5]→B=B_{O1-O2}

BD[6]→B=B_{O1-H1}

BD[7]→B=B_{O1-H2}

BD[8]→B=B_{O2-H1}

BD[9]→B=B_{O2-H2}

BD[10]→B=B_{H1-H2}

The electron density calculation part 32 allocates the element pair-identifying data (A) of the atom pairs to the index value-containing data (BD) 73.

The element pair-identifying data (A) of the atom pairs is allocated to the index value-containing data (BD) 73 as follows:

BD[1,2]→A=1

BD[3,4]→A=2

BD[5]→A=3

BD[6,7,8,9]→A=4

BD[10]→A=5

The electron density calculation part 32 determines the pair type of each atom pair.

In particular, the coefficient flags (F) of the index value-containing data (BD) 73 are determined as follows:

BD[1]→F=4

BD[2]→F=3

BD[3]→F=4

BD[4]→F=2

BD[5]→F=3

BD[6]→F=4

BD[7]→F=2

BD[8]→F=3

BD[9]→F=1

BD[10]→F=2

In order to consider the electron density of the entire molecule, the pKₐ prediction part 34 groups atom pairs including the atom “H2” defined as the target proton (target proton itself) or the atom “O2” (atom directly connected to target proton) in terms of weighting. With reference to the coefficient flags (F) that represent the pair types, the categories of the weighting are determined. The atom pairs of the same pair type are weighted into the same category. In this case, the atom pairs of the coefficient flag (F) “4” are not considered.

The atom pairs are classified into the categories of weighting as follows:

Weighting 1: O2-O1, O2-H1, and O2-C

Weighting 2: H2-O1, H2-H1, and H2-C

Weighting 3: O2-H2

The pKₐ prediction part 34 classifies the atom pairs grouped in terms of weighting into index value groups. In the index value groups, the target proton or the atom X directly bonded to the target proton is paired with the element corresponding to the atom combined therewith (hereinafter referred to as index value pair), thereby grouping the weighted atom pairs. The weighted atom pairs correspond to the atom pairs having the coefficient flags (F) “1”, “2”, and “3”.

Identification data is allocated to each index value group, for example, as follows:

O2-O: 1

O2-H: 2

O2-C: 3

H2-O: 4

H2-H: 5

H2-C: 6

These numbers are determined as the group-identifying data (G) of the index value group-containing data (GD) 75.

Then, the pKₐ prediction part 34 multiplies the index value (B) of the atom pair (O2-X, H2-X, or O2-H2) by the coefficient value (C[F]) of the element pair in each index value group GD [G]. The coefficient (C[F]) of the element pair is specified by the number “1”, “2”, or “3” of the coefficient flag (F).

The index value group “1” has one atom pair. The atom pair “O1-O2” has atom pair-identifying data “5”, and the element pair “O—O” thereof has element pair-identifying data “3”. In addition, the coefficient flag that specifies the weighting of the atom pair “O1-O2” is “3”.

In particular, the following relationship is obtained:

GD[1]→N[1]=5, BD[5]→A=3, BD[5]→F=3

therefore,

AD[3]→C[3]×BD[5]→B

accordingly,

C_{O-O}(3)×B_{O1-O2}.

Similarly, the index value group “2” has two atom pairs. The following relationships are obtained:

GD[2]→N[1]=8, BD[8]→A=4, BD[8]→F=3

therefore,

AD[4]→C[3]×BD[8]→B

accordingly,

C_{O-H}(3)×B_{O2-H1}; and

GD[2]→N[2]=9, BD[9]→A=4, BD[9]→F=1

therefore

AD[4]→C[1]×BD[9]→B

accordingly

C_{O-H}(1)×B_{O2-H2}.

The index value group “3” has one atom pair. In particular, the following relationship is obtained:

GD[3]→N[1]=2, BD[2]→A=1, BD[2]→F=3

therefore,

AD[1]→C[3]×BD[2]→B

accordingly,

C_{C-O}(1)×B_{C-O2}.

The index value group “4” has two atom pairs. In particular, the following relationships are obtained:

GD[4]→N[1]=7, BD[7]→A=4, BD[7]→F=2

therefore,

AD[4]→C[2]×BD[7]→B

accordingly,

C_{C-H}(2)×B_{O1-H2}; and

GD[4]→N[2]=9, BD[9]→A=4, BD[9]→F=1

therefore,

AD[4]→C[1]×BD[9]→B

accordingly,

C_{O-H}(1)×B_{O2-H2}.

The index value group “5” has one atom pair. In particular, the following relationship is obtained:

GD[5]→N[1]=10, BD[10]→A=5, BD[10]→F=2

therefore,

AD[5]→C[2]×BD[10]→B

accordingly,

C_{H-H}(2)×B_{H1-H2}.

The index value group “6” has one atom pair. In particular, the following relationship is obtained:

GD[6]→N[1]=4, BD[4]→A=2, BD[4]→F=2

therefore,

AD[2]→C[2]×BD[4]→B

accordingly,

C_{C-H}(2)×B_{C-H2}.

The above-mentioned results of the multiplication are added together.

pKₐ=constant+C_{O-H}(1)×B_{O2-H2}

+C_{O-O}(3)×B_{O1-O2}

+C_{O-H}(3)×B_{O2-H1}

+C_{C-O}(3)×B_{C-O2}

+C_{O-H}(2)×B_{O1-H2}

+C_{H-H}(2)×B_{H1-H2}

+C_{C-H}(2)×B_{C-H2}

This process enables prediction of an acid dissociation constant pKₐ based on O2-H2 of formic acid.

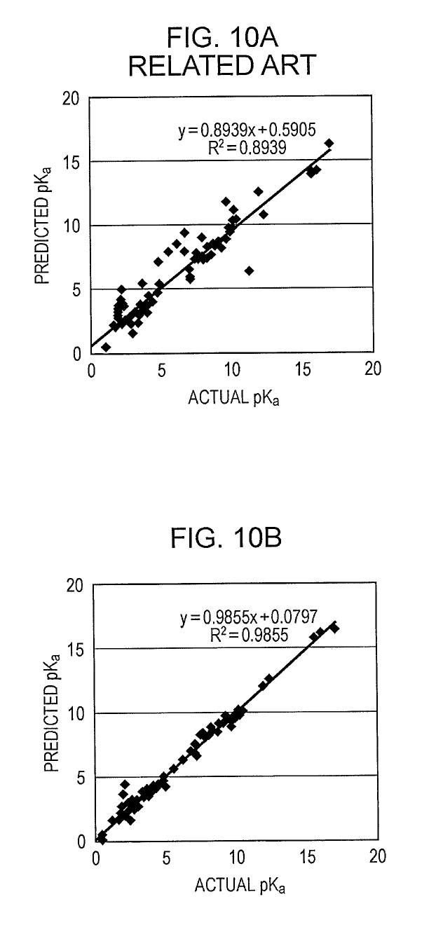

A process for predicting an acid dissociation constant according to the embodiment has been described with reference to an example of the molecular structure of formic acid in FIG. 9; furthermore, the inventor has obtained correlations between actual values and predicted values of 103 molecules that are analysis subjects. FIGS. 10A and 10B illustrate effects of the embodiment. FIG. 10A illustrates results of analysis by the technique disclosed in Jahanbakhsh Ghasemi, Saadi Saaidpour, Steven D. Brown, “QSPRstudy for estimation of acidity constants of some aromatic acids derivatives using multiple linear regression (MLR) analysis”, Journal of Molecular Structure, THEOCHEM, pp. 27-32, 2007. In the analysis in FIG. 10A, the relationship of x=121.4191−240.451 pchgH−43.4984 bl(O—H)+24.30716 pchgO is provided.

FIG. 10B illustrates results of analysis by the embodiment. In FIG. 10B, electron density is defined by Austin model 1 (AM1) disclosed in Jahanbakhsh Ghasemi, Saadi Saaidpour, Steven D. Brown, “QSPRstudy for estimation of acidity constants of some aromatic acids derivatives using multiple linear regression (MLR) analysis”, Journal of Molecular Structure, THEOCHEM, pp. 27-32, 2007; and index values are calculated on the basis of Index of Wiberg (Formula described above) disclosed in I. Mayer, “Bond Order and Valence Indices: A Personal Account”, Journal of Computational Chemistry Special Issue, Vol. 28, No. 1, Wiley InterScience, Wiley Periodicals, Inc., pp. 204-221, 2007.

A correlation R² is approximately 0.89 in the related art as illustrated in FIG. 10A; in contrast, a correlation R² is approximately 0.99 in the embodiment as illustrated in FIG. 10B, which elucidates that the embodiment may provide highly accurate results even through a calculation that is as fast as the calculation by the technique disclosed in Jahanbakhsh Ghasemi, Saadi Saaidpour, Steven D. Brown, “QSPRstudy for prediction of acidity constants of some aromatic acids derivatives using multiple linear regression (MLR) analysis”, Journal of Molecular Structure, THEOCHEM, pp. 27-32, 2007.

As described above, an index (for example, bond order) based on the electron density of an intermolecular bond is utilized, which enables fast and highly accurate prediction of the acid dissociation constant pKa of a target molecule regardless of the types of molecules.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus for predicting an acid dissociation constant, the apparatus comprising:
a memory configured to store index value-containing data, element pair-containing data, and index value group-containing data, the index value-containing data containing an index value of an interatomic bond of a target molecule determined on the basis of the value of the electron density of the interatomic bond, the element pair-containing data containing a coefficient value specific to two elements that serves for the interatomic bond, the index value group-containing data entirely covering the target molecule and being based on the index value-containing data and the element pair-containing data; and
an acid dissociation constant prediction unit that predicts an acid dissociation constant from the index value group-containing data and the element pair-containing data.

2. The apparatus according to claim 1,
wherein the index value-containing data further includes
atom pair-identifying data that serves to identify the interatomic bond of the target molecule,
element pair-identifying data that serves to identify a combination of two elements included in the interatomic bond, and
coefficient flag data that serves to identify the type of an atom pair; and
the index value-containing data has a data structure that gives accessibility from the atom pair-identifying data to the index value and the element pair-distinguish data.

3. The apparatus according to claim 2,
wherein the element pair-containing data contains the coefficient value by the type of an atom pair;
the element pair-containing data further includes element pair-identifying data that serves to specify an element pair corresponding to the atom pair, and
atom pair-identifying data that holds the element pair corresponding to the atom pair and that is stored in the index value-containing data; and
the element pair-containing data has a data structure which gives accessibility from the element pair-identifying data to the coefficient value and the atom pair-identifying data.

4. The apparatus according to claim 3,
wherein interatomic bonds including a hydrogen atom corresponding to a proton dissociated in the target molecule, a first atom directly bonded to the proton, a second atom other than the first atom, or any combination thereof are grouped into a first atom pair including the proton, a second atom pair including the first atom, and a third atom pair including the proton and the first atom on the basis of the element pair-identifying data;
the index value group-containing data includes group-identifying data and the atom pair-identifying data, the group-identifying data serving to identify the groups; and
the atom pair-identifying data specifies an atom pair included in a group.

5. The apparatus according to claim 4,
wherein the acid dissociation constant prediction unit predicts an acid dissociation constant for each group from a function in which the coefficient value and that index value are used, the coefficient value being accessible from the element pair-identifying data of the index value-containing data, the index value being accessible from atom the pair-identifying data accessible from the element pair-identifying data.

6. A method for predicting an acid dissociation constant with a computer, the method comprising:
predicting an acid dissociation coefficient based on a target proton of a molecular structure stored in a memory and an atom directly bonded to the target proton through the sum of product of an index value and a coefficient value given to an element pair corresponding to the atom pair, the index value being bond strength of an atom pair that includes any one of bonding to the target proton and bonding to the atom.

7. A computer-readable storage medium that stores a program configured to allow a computer to carry out a process for predicting an acid dissociation coefficient based on a target proton of a molecular structure stored in a memory and an atom directly bonded to the target proton through the sum of product of an index value and a coefficient value given to an element pair corresponding to the atom pair, the index value being bond strength of an atom pair that includes any one of bonding to the target proton and bonding to the atom.
